(19) United States
(12) Patent Application Publication
(10) Pub. No.: US 2012/0121809 A1
(43) Pub. Date: May 17, 2012

(54) FORMULATION AND PROCESS FOR TREATING WOOD SUBSTRATES

(76) Inventor: Mark Vuozzo, Solana Beach, CA (US)

(21) Appl. No.: 13/283,542

(22) Filed: Oct. 27, 2011

Related U.S. Application Data
(60) Provisional application No. 61/407,064, filed on Oct. 27, 2010.

(51) Int. Cl. B05D 7/06; C09D 5/16; B05D 3/02

(52) U.S. Cl. 427/317; 427/314; 427/440; 523/122

(57) ABSTRACT

The present invention discloses a composition and method for the treatment of substrates such as, for example, wood. The inventive composition and method are useful for the treatment, protection and maintenance of wood and other similar materials.

### CROSS REFERENCE TO RELATED APPLICATIONS

This application claims priority from U.S. Provisional Patent Application Ser. No. 61/407,064, entitled “Formulation and Process for Treating Wood Substrates,” filed on Oct. 27, 2010.

### FIELD OF THE INVENTION

The present invention relates generally to wood product preservatives, and more particularly to wood product preservative compositions including at least one boron-containing material and at least one acrylate copolymer.

### BACKGROUND OF THE INVENTION

This invention discloses a composition and method for the treatment of substrates such as, for example, wood. The use of wood products, such as lumber, in modern society is extremely widespread. For example, wood products are found in housing construction materials, crating materials, utility pole materials, fencing materials, indoor and outdoor furniture, as well as many other residential, industrial and commercial applications.

Although wood is an extremely useful and versatile material to employ with respect to the aforementioned applications, it does suffer from certain disadvantages. This is especially true with respect to wood products that are used primarily for outdoor applications.

For example, wood, especially untreated wood, is susceptible to damage caused by the elements, especially water, as well as insects (e.g., termites, certain types of ants, and other boring insects), mold and the like.

Water damage typically causes wood products to warp, crack, check, as well as become discolored and mildewed. Insect damage typically causes wood products to rot and decay. Typically, water and/or insect damage leads to the eventual replacement of the damaged section of wood at great expense, effort, and inconvenience.

Wood preservative and protectant manufacturers have marketed various wood treatment products to supposedly prevent, or reduce the likelihood of, the occurrence of water and insect damage to wood products. For example, in the pressure treatment of wood, various active ingredients such as fungicides or other wood preservatives are impregnated deeply into wood through the application of pressure. A well known example of such pressure treated wood is wood intended for outdoor use in fences or decks and impregnated with preservatives to prevent deterioration of the wood through the action of the elements or from insects or microbes.

These products have not been completely satisfactory, especially with regard to effectiveness, safety, cost concerns, ease of application, duration of treatment time, and duration of protection afforded. Most treated wood that is used outdoors is exposed frequently to water, which is able to seep into the prior art pressure treated wood. The movement of water in and out of the wood causes two things to occur. First, the water dissolves any water soluble active ingredients and extracts those ingredients from the wood, thereby reducing the beneficial properties the ingredients may have imparted, such as rot prevention or flame retardant. Second, the water causes dimensional instability of the wood, which can take the form of splitting and cracking upon freezing.

An effective active ingredient commonly used for the pressure treatment of wood is Copper Chrome Arsenate (CCA), a heavy metal. The possibility of leaching has caused some persons to criticize the use of CCA due to the toxicity of CCA.

The problem of leaching of active ingredients from pressure treated wood is recognized in the prior art, and attempts have been made to address the problem. One prior art attempt at a solution is to use polymeric binders to secure particles of an active ingredient to the wood. These polymeric binders typically use aminoplast curing agents that have the undesirable characteristic of generating formaldehyde. Formaldehyde has various undesirable characteristics, such as generating odors. Formaldehyde also is a suspected carcinogen.

U.S. Pat. No. 6,235,346 discloses a process for pressure treating wood by infusing into the wood an aqueous solution of an anhydride, followed by removal of moisture from the wood and then infusing into the wood a molten waxy solid comprising hydrocarbon paraffins or saturated fatty acids.

U.S. Pat. No. 7,008,997 discloses a process to treat wood with a blend comprising an oligomeric mixture of amines and diisocyanates to provide water barrier and barrier against fungal and environmental damages.

EP 1985181A2 discloses a wood preserving composition comprising mixtures of a boron-containing material, a silane-containing material and an organic solvent (such as a hydrocarbon).

There exists a need for preservative compositions for various wood products that will provide satisfactory protection against water, fungal attack and insect damage, as well as being highly effective, relatively inexpensive, relatively easy to apply, have a relatively short treatment time, free of materials such as CCA and formaldehyde, and provide a relatively long period of protection. Moreover, one of the novel aspects of the invention is that wood preservation can be applied to all vertical members used to frame a home or structure and not just the exposed outdoor uses. This is a key component of the invention. The wood preservative of the present invention is a topical coating and does not modify the structural integrity of the wood; it is suitable to be applied to all vertical framing members. Of course, the compositions of the present invention will be very effective in an outdoor or exposed use as well. Improved methods for treatment of wood are of considerable interest both in residential and commercial arenas.

### SUMMARY OF THE INVENTION

It is an object of the present invention to provide new and improved preservative compositions for wood products and methods for using same.

It is another object of the present invention to provide new and improved preservative compositions for wood products and methods for using same, wherein the preservative compositions protect the wood products against water damage and/or insect damage.

It is another object of the present invention to provide new and improved preservative compositions for wood products and methods for using same, wherein the preservative compositions contain at least one boron-containing material and at least one polymeric material.

It is another object of the present invention to provide new and improved preservative compositions for wood products and methods for using same, wherein the preservative compositions contain at least one boron-containing material and at least one acrylate copolymeric material (sometimes referred to as acrylic copolymeric material herein).

It is another object of the present invention to provide new and improved preservative compositions for wood products and methods for using same, wherein the preservative compositions contain at least one boron-containing material, at least one acrylate copolymeric material, and water.

It is another object of the present invention to provide new and improved preservative compositions for wood products and methods for using same, wherein the preservative compositions contain at least one boron-containing material, at least one acrylate copolymeric material, a fire retardant/inhibitor material and water.

It is another object of the present invention to provide new and improved preservative compositions for wood products and methods for using same, wherein the preservative compositions contain at least one boron-containing material, at least one acrylate copolymeric material, a fire retardant/inhibitor material, a colorant (or dye or pigment) and water.

### BRIEF DESCRIPTION OF THE DRAWINGS

FIG. 1 is a graph comparing flame spread on a Douglas Fir 2×4 with and without fire retardant/inhibitor.

FIG. 2 is a graph comparing smoke developed on a Douglas Fir 2×4 with and without fire retardant/inhibitor.

FIG. 3 is a graph comparing flame spread on a Douglas Fir 2×6 with and without fire retardant/inhibitor.

FIG. 4 is a graph comparing smoke developed on a Douglas Fir 2×6 with and without fire retardant/inhibitor.

FIG. 5 is a graph comparing flame spread on an Oriented Strand Board with and without fire retardant/inhibitor.

FIG. 6 is a graph comparing flame spread on an Oriented Strand Board with and without fire retardant/inhibitor.

FIGS. 7 and 8 are bar graphs comparing the Modulus of Elasticity, Modulus of Rupture, and Energy (and their standard deviations) for untreated and treated wood products.

FIG. 9 is a schematic drawing depicting a partially or fully automated system for creating the invention formulation.

FIG. 10 is a schematic drawing depicting a partially or fully automated system for mixing and measuring components used in the invention formulation.

FIG. 11 is a schematic drawing depicting a partially or fully automated system for methods of using the invention formulation, including partially or fully automated methods of coating substrates including wood products.

### DETAILED DESCRIPTION OF THE INVENTION

The present invention as described below includes compositions, and method of use therefor, for preserving, protecting, and treating wood and wood products so as to impart protection against various sources of damage, including, but not limited to water, mold/wood rot, fire and/or insects. The terms “preserving,” “protecting,” and treating,” as those terms are used interchangeably herein, are meant to include any methods of, and compositions for, protecting wood and wood products from damage caused by any source, including, but not limited to water, mold/wood rot, fire and/or insects. The terms “wood” and “wood products,” as those terms are used interchangeably herein, are meant to include any object containing any amount of wood.

In accordance with an embodiment of the present invention, a preservative composition for wood products is provided, comprising: a borate pesticide and a film-forming acrylate copolymer.

In accordance with another embodiment of the present invention, herein provided is a process for treating a wood substrate comprising the steps of:
(a) optionally drying the substrate to a moisture content below twenty percent;
(b) diluting a suitable acrylate copolymer with water;
(c) adding a suitable borate pesticide to the solution of step (b);
(d) optionally adding a suitable fire retardant/inhibitor;
(e) adding water to the solution of step (c) or step (d) to prepare a diluted coating solution suitable to adhere to the substrate surface into the substrate when applied to the substrate; and
(f) applying the diluted coating solution from step (e) to the substrate.

In accordance with another embodiment of the present invention, herein provided is a process for treating a wood substrate comprising the steps of:
(a) optionally drying the substrate to a moisture content below twenty percent;
(b) diluting a suitable acrylate copolymer with water;
(c) adding a suitable borate pesticide to the solution of step (b);
(d) optionally adding a suitable fire retardant/inhibitor;
(e) optionally adding one or more wet state biocides, one or more dry film fungicides or a combination of the same;
(f) adding water to the solution of step (c) or step (d) to prepare a diluted coating solution suitable to adhere to the substrate surface into the substrate when applied to the substrate; and
(g) applying the diluted coating solution from step (e) to the substrate.

Since water is the main diluting solvent in the inventive process, all the materials selected should be water soluble or aqueous. Despite the water solubility of the materials, the copolymers used herein change the permeability of the substrate (for example wood products) slowing down water penetration and reducing the checking and warpage of the wood products. The copolymers also create a barrier that prevents, reduces and/or slows solids in the mixture from washing off or leaching out of the substrate.

Suitable acrylate copolymer is a film-forming copolymer comprising monomeric units selected from acrylic monomers such as, for example, methyl acrylate, ethyl acrylate, butyl acrylate, pentyl acrylate, acrylic acid and the like, or combinations thereof. Non-limiting examples of suitable comonomers include monomer such as, for example, styrene, butadiene, acrylonitrile and similar such materials.

Suitable acrylate copolymer should be of molecular weight high enough to be film-forming. Preferred copolymer has a minimum film forming temperature (“MFFT”) in the range of about 4-10° C., more preferably about 5° C.

Additionally, suitable acrylate copolymer has a pH of about 6-10, preferably about 7-9, more preferably about 7-8.

Suitable such acrylate copolymers can be synthesized by well known processes in the art or commercially purchased. Several such acrylate copolymers are commercially available. Non-limiting examples of suitable commercially available acrylate copolymers include the Syntran® brand acrylic copolymer available from Interpolymer Corporation, Canton, Mass. Several Syntran® brand copolymers are available such as, for example, Syntran 4015®, Syntran 4020®, Syntran 4022®, Syntran 4018®, Syntran 6200® and the like. A copolymer particularly suitable in the practice of the present invention is the Syntran 6200® brand copolymer and also known as ECB824BP in internal testing and use.

Borate pesticides are well known in the art. Many are commercially available. Non-limiting examples of suitable borate pesticides include, for example, boric anhydride (chemical formula: B₂O₃), borax (chemical formula: Na₂B₄O_{7.}10H₂O), and disodium octaborate tetrahydrate (chemical formula: Na₂B₈O₁₃.4H₂O). A particularly suitable borate pesticide compound is disodium octaborate tetrahydrate (DOT). Disodium octaborate tetrahydrate is commercially available under names such as Polybor® (from U.S. Borax, Inc., Valencia, Calif.) or Polybor 3® (also from U.S. Borax, Inc.) and Cellu-Treat® (from Nisus Corporation, Rockford, Tenn.). A borate pesticide particularly suitable in the invention is Cellu-Treat® brand disodium octaborate tetrahydrate. Another borate pesticide particularly suitable in the invention is Borasol-WP from Quality Borate Company.

A preferred embodiment of the present invention is the ability to flood coat and/or wet stack the wood coated with present invention without the necessity of drying, heat treating or pressure treating. Though drying may be optionally used, the present invention is not dependent upon heat or pressure to achieve penetration into the wood products. Drying may be used especially when the moisture content of the wood products is greater than 20%. Optional drying may include air drying, forced air, radiant heat and/or infra-red heat. Flood coating reduces the time and labor involved in applying the invention treatment to the wood because heat or pressure impregnation is not required. Wet stacking reduces the time and labor involved in the methods of the present because the coated wood can be immediately stored without reducing the effectiveness of the treatment. Both of these advantages reduce costs without reducing effectiveness. The present invention also protects against microbial, fungal, and algae growth that may commonly occur with flood coating and/or wet stacking through the use of broad spectrum wet state biocides and/or dry film fungicides, mildewcides and algaecides.

Methylisothiazolinone (2-methyl-4-isothiazolin-3-one) (MIT) and chloromethylisothiazolinone (5-chloro-2-methyl-4-isothiazolin-3-one) (CMIT) are “wet state” preservatives or biocides that can be utilized for controlling microbial growth in water-containing solutions. CMIT/MIT are often combined in water-based and water soluble formulations well known in the art. One such formulation suitable for use with the present invention is Mergal® K14 (EPA Registration No. 5383-104) commercially available from Troy Chemical Corporation (8 Vreeland Road, PO Box 955, Florham Park, N.J., USA 07932—www.troycorp.com) but other suitable CMIT/MIT formulations may also be used. A preferred aspect of the invention is the ability to use relatively small amounts of wet state biocides and still achieve microbial growth control or elimination. As a non-limiting example, CMIT/MIT may used in the invention formulation such that the active ingredient(s) is in the range of about 500-1500 parts per million (PPM), more preferably in the range of about 750-1250 PPM, and even more preferably in the range of about 850-1050 PPM. Preparation of such broad spectrum wet state preservatives (as a part of the overall invention formulation) such that the active ingredient is within the ranges set forth above is commonly understood by those of skill in the art.

Other broad spectrum dry film fungicides, mildewcides and algaecides can be incorporated into the present invention including,those containing 3-Iodo-2-propynyl butylcarbamate (IPBC). As non-limiting examples, suitable IPBC formulations are commercially available from Troy Chemical Corporation and sold as Polyphase® 678 (EPA Registration No. 5383-110) and Polyphase® PW40 (EPA Registration No. 5383-63) but other suitable IPBC formulations may also be used. Another advantage of using IPBC is it is substantially devoid of volatile organic compounds (VOCs). A preferred aspect of the invention is the ability to use relatively small amounts of broad spectrum dry film fungicides still achieve fungal, mildew and/or algae growth control or elimination. As a non-limiting example, IPBC may be used in the invention formulation such that the active ingredient(s) is in the range of about 2000-10000 parts per million (PPM), more preferably in the range of about 2500-8500 PPM, and even more preferably in the range of about 3000-4000 PPM. Preparation of such broad spectrum dry film fungicides (as a part of the overall invention formulation) such that the active ingredient is within the ranges set forth above is commonly understood by those of skill in the art.

A preferred embodiment of the present inventive formulations and methods is the ability to coat wood products that have high moisture content. Moisture content can measured using commercially available meters that measure below the surface of the substrate and use a specific gravity calculation based upon species of lumber. One example of a commercially available moisture content meter is a Wagner MMC220. High moisture content, such as greater than about 19%, is sometimes referred to as “green wood.” Green wood is more prone to mold growth both on the wood itself and also in coatings that may be applied to wood products. The formulations herein allow effective coating with substrate on wood products that have not been kiln dried or heat treated.

If fire retardant ability is desired, suitable fire retardant (sometimes referred to as fire inhibitor herein) materials can be used in the instant formulation provided that the fire retardant materials are water soluble. Many such products are commercially available though few such products are non-toxic and water soluble. A product particularly suitable in the practice of the present invention is the Hartindo™ AF21 fire inhibiting product (“AF21”) available from Newstar Chemicals (M) Sdn Bhd.

Thus, in accordance with an embodiment of the present invention, an aqueous composition for treating a wood substrate with a solids content of about 5 to 30%, preferably 17-20% and able to have the solids adhere to the substrate surface when applied to said substrate is provided, said composition comprising: (a) the Syntran 6200® brand copolymer having a minimum film forming temperature in the range of about 4-10° C. and a pH of about 6-10, (b) disodium octaborate tetrahydrate, (c) water, and (d) optionally the AF21® brand fire inhibitor.

If coloring of the wood is desired, suitable colorants or dyes or pigments can be added to the formulation. Colors such as blue, red, green and the like can be selected provided that they are water-soluble.

Another embodiment of the present invention is the process of forming the inventive formulation and the process of treating the desired substrate. The substrate may be used as such without any pre-treatment or suitably pre-treated if so desired. Sometimes drying of the substrate prior to applying the formulation may be desired. If so, the substrate may be optionally dried to specified water content, for example, below 20%, or in the case of some woods or wood products, 15-19% or less.

A particularly useful step in the process is the dilution step or steps. The acrylic copolymer, for example, the Syntran® brand copolymer or a suitably modified form of Syntran® such as, for example, the “Syntran® Concentrate” commercially available from Interpolymer Corporation, is initially diluted with water such that the solids content of the solution after dilution is generally below about 50% (weight percent), and preferably below about 25%. Applicants have found that this dilution helps the further formulating steps as well as in the coating process.

The selected borate pesticide, for example, Borasol-WP from Quality Borate Company, is added to the diluted solution described above in amounts sufficient to impart fungal-decay resistance and insect resistance to the wood after applying the formulation.

If a fire retardant is desired, a suitable fire retardant material such as, for example, the AF21™ brand fire inhibitor may be added to the solution.

Whether a fire retardant is added or not, water is now added to the borate (or borate and fire retardant) containing solution to bring the solids content down to generally below about 20%, preferably below about 15% and more preferably below about 10%. Here too, applicants have noted that such dilution brings about desirable coating of the wood as well as imparting desirable film forming properties to the coated wood.

If a colorant (or dye or pigment) is desired to be added to the formulation, it may be added at any step during the preparation of the formulation. Thus, the colorant may be added before adding the borate pesticide material or after adding the borate pesticide material. Either way, the ultimate diluted solution is preferably in the dilution range where the solids content is down to generally below about 20%, preferably below about 15% and more preferably below about 10%.

The thus-prepared formulation may be applied to the wood surface by standard procedures well known to those skilled in the art. Applying preservative solution to wood is a well practiced art in residential, industrial and commercial areas. The application method generally depends on factors such as, for example, the size of the substrate being coated as Well as whether the intended use is for residential, commercial or industrial use.

Non-limiting examples of such uses include: wood and other building and/or construction materials, namely, wood beams, wood boards, wood joists, wood rafters, wood siding, wood tile floors and flooring, wood trim, wooden beams, wooden flooring, wooden railings, wooden wainscoting, vertical structural and architectural framing members formed of pressed wood fibers, particle board, laminated veneer lumber, glue laminated wood beams, parallel strand lumber, timber, oriented strand board wood trim, concrete form boards, non-metal roof trusses, oriented strand wood board, non-metal siding, facia, non-metal decking, plywood, open web joists, construction timber and non-metal self-aligning demountable press studs for use in attaching panels in buildings.

Without any intention to hypothesize or being held to any theory, it is believed that the application of the inventive preservative solution to wood to form a surface film creates a semi-permeable moisture barrier controlling the moisture content of wood substrates. It is further believed that the inventive wood surface film bonds with the wood fibers at the cellulose level locking the borate pesticide and/or fire retardant/inhibitor into the substrate for long life of the product without significant leaching of the preservative material(s). The moisture barrier is highly effective inhibiting the growth of mold/mycotoxins, prevention of wood rot and eliminating the attack of wood ingesting insects such as termites including Formosan termites. It is further believed that the instant coating film forms eliminating oxygen and taking away a food source of mold while controlling the rate in which moisture will escape from the wood substrate preventing lumber products from twisting/checking and swelling.

Non-limiting formulations and processes of the invention are described below.

EXAMPLES: The following examples illustrate the novel compositions and methods of the invention.

### EXAMPLE 1

STEP 1: Two Concentrates containing Syntran 6200® and disodium octaborate tetrahydrate (Nisus Cellu-Treat) were prepared as follows: Concentrate 1 contained Syntran 6200®, disodium octaborate tetrahydrate and a dye (blue dye). Concentrate 2 contained Syntran 6200® and disodium octaborate tetrahydrate with no dye. All water was filtered to zero solids prior to use.

TABLE 1

WT in
grams

Concentrate 1

| | |
|---|---|
| With Stir Bar | 110.9 |
| Syntran 6200 Concentrate | 20 |
| Beaker# 11 | 60 |
| Blue Dye | 3.6 |
| Total WT | 194.5 |
| 1 oz = ~29.98 gr | |

Concentrate 2

| | |
|---|---|
| With Stir Bar | 72.6 |
| H2O | 89.2 |
| Corn Syrup | 20 |
| Total WT | 181.8 |

TABLE 2
Assay for Solids Content

| | |
|---|---|
| Cup | 1.3 |
| Gross Wet wt | 11.3 |
| Net Wet wt | 10 |
| Gross Dry wt | 3 |
| Net Dry wt | 1.7 |
| Delta Wet/Dry | 8.30 |
| % Solids | 20.48% |

STEP 2: Formulation 1 and Formulation 2 for coating the wood surface were prepared from Concentrate 1 and Concentrate 2, respectively, as follows:

TABLE 3

| | | |
|---|---|---|
| Formulation 1 (10 oz) | With Stir | 261.4 |
| H₂O | 4.5 oz | 133 |
| AF21 | 4.5 oz | 156.9 |
| Concentrate 1 | 1 oz | 30 |
| DOT | 15% | 48 |
| Formulation 2 (15 oz) | With Stir | 262.8 |
| H₂O | 13.5 oz | 399.2 |
| Concentrate 2 | 1.5 oz | 45 |
| DOT | 15% | 66.6 |

STEP 3: Specimen wood samples were coated as follows (OSB: Oriented Strand Board; Raw: Uncoated (control)).

TABLE 4

| Test | | |
|---|---|---|
| Sample | | Coated with |
| ID | Description | Formulation No. |
| O1 | OSB - 4⅜ × 4⅜ × ½ inch | Raw |
| O2 | OSB - 4⅜ × 4⅜ × ½ inch | 2 |
| O3 | OSB - 4⅜ × 4⅜ × ½ inch | 1 |
| D1 | Doug Fir - 3⅜ × 4¼ × 1½ inch | Raw |
| D2 | Doug Fir - 3⅜ × 4¼ × 1½ inch | 2 |
| D3 | Doug Fir - 3⅜ × 4¼ × 1½ inch | 1 |
| S1 | Spruce-Pine-Fir - 4¼ × 5⅜ × 1⅜ inch | Raw |
| S2 | Spruce-Pine-Fir - 4¼ × 5⅜ × 1⅜ inch | 2 |
| S3 | Spruce-Pine-Fir - 4¼ × 5⅜ × 1⅜ inch | 1 |

STEP 4: The following organisms were used to inoculate all portions of samples:

| | |
|---|---|
| 1. | Fusarium solani |
| 2. | Chaetomhim sp. |
| 3. | Penicillium chrysogenum |
| 3. | Stachybotrys echinata |
| 5. | Aspergillus niger |
| 6. | Penicillium verrucosum |
| 7. | Aspergillus fumigates |
| 8. | Curvularia sp. |
| 9. | Penicillium corylophilicum |
| 10. | Penicillium crustosum |

All organisms were obtained from American Type Culture Collection (ATCC) or College of American Pathology (CAP) or from environmental samples which previously had the fungal organisms present. All samples were maintained in pure culture. Samples were incubated at 28° C. for up to 18 days after initial testing and inoculation. Humidity was maintained at 40-50% in the enclosed incubator.

Procedure: A. Initial testing: The submitted samples were swabbed with sterile saline moistened swabs and plated on Potato Dextrose Media (PDM). Plates were examined for 14 days for fungal and/or bacterial growth. Also, samples were swabbed with sterile saline moistened swabs and the swabs were placed in 1.0 ml of Phosphate Buffered Saline (PBS) with 10% Methanol. These samples were used to conduct Enzyme Linked ImmunoSorbant Assays (ELISA) testing for mycotoxins. The mycotoxins tested were: Aflatoxin BI, B2, GI, G2; Ochratoxin A, and macrocyclic trichothecenes. Samples were read on an ELISA reader at 450 A and 650 A. Tests were conducted using in-house proprietary procedures and reported in parts per billion (ppb) or ng/ml.

Minimal Levels of Detection (LOD) for each mycotoxin is as follows: Aflatoxins-1.0 ppb (ng/ml)
Ochratoxins-2.0 ppb (ng/ml)
Tricothecenes-0.2 ppb (ng/ml)

B. Inoculation of samples: Samples were then inoculated with known control organisms (listed above). All fungal organisms were initially cultured on PDM for 14 days prior to diluting in sterile distilled water. An inocula from the PDM was taken and placed in 3 cc. of sterile distilled water. Each inocula was then counted using a hemocytometer and inoculums were adjusted to approximately 450 spores/ml. The final dilution (450 spores/ml) was labeled at “Neat” or undiluted. The organism concentration was determined to be a final concentration of 450 spores/ml in the mixture used to inoculate each board. 100 μl (0.1 cc) of the final concentration was placed on each piece of sample. For example, 0.1 cc of the Neat solution was placed on the upper left corner for a final volume of 450 spores. The assumption of the final concentration would be if ANY spore is present in the solution, it should either grow or be inhibited. Samples were placed in the incubator at 30-40% humidity and evaluated weekly for a total of 13 days. Samples were evaluated for visible mold growth and were rated in the following manner:

Mold Growth Present and/or Bacterial Growth present: Actual numbers of colonies were not counted on the material because of the confluent growth on the wood.

C. Final culture and mycotoxin testing. At the end of 13 days, the samples were swabbed using a sterile saline moistened swab and then inoculated onto PDM. Plates were then incubated for 2-5 days at 28° C. and evaluated for mold growth. Samples were also swabbed with a sterile saline moistened swab and placed in 1.0 ml PBS with 10% Methanol for final ELISA testing. Samples were read in the same manner as the initial ELISA tests.

Results: A. Initial Culture: No fungal elements were noted on all Formulation 1 and Formulation 2 coated samples as well as the raw wood.

B. Initial mycotoxin ELISA testing: Results of ELISA testing for the total mycotoxin panel (Aflatoxin, Ochratoxin, and Tricothecenes) showed no mycotoxins present on any of the samples submitted.

C. Final Culture Results: Results of the cultures conducted at the end of project showed that samples coated with Formulation and Formulation 2 inhibited fungal growth at all concentrations of fungi. No bacteria were noted as well. Samples of non-coated wood showed fungal growth on all samples of raw wood. Additionally, the treated wood demonstrated no visible mold growth. However, water stains were present. Subsequent cultures of all areas that were inoculated showed no mold growth after 10 days.

D. Final ELISA Results for Mycotoxin Testing: Results of mycotoxin testing are summarized as follows. The term “treated samples” in this section D refers to samples treated with both Formulation 1 and Formulation 2.

Aflatoxins—were present in the non-treated wood at levels of 1.0-1.3 ppb. No Aflatoxins were found in the treated samples.

Ochratoxins—were present in the non-treated wood samples at 2.1-2.2 ppb. No Ochratoxins were found in the treated samples.

Tricothecenes—No Tricothecenes were found in both the treated or non treated samples.

CONCLUSIONS: 1. The wood products treated with the formulations according to the present invention do inhibit the growth of toxin producing fungal elements, specifically:

| | |
|---|---|
| 1. | Fusarium solani |
| 2. | Chaetomhim sp. |
| 3. | Penicillium chrysogenum |
| 4. | Stachybotrys echinata |
| 5. | Aspergillus niger |
| 6. | Penicillium verrucosum |
| 7. | Aspergillus fumigates |
| 8. | Curvularia sp. |
| 9. | Penicillium corylophilicum |
| 10. | Penicillium crustosum |

2. Because the formulations according to the present invention inhibit toxin producing fungal elements, no mycotoxins could be produced. No mycotoxins were found on any wood treated with the formulations according to the present invention, Formulation 1 and Formulation 2.

Additional preferred embodiments of the formulations of the present invention are presented as concentrates and application mixtures made therefrom in Tables 5-12 below. Formulation components (listed under the “description” heading) are added in order in accordance with the instructions (listed under the “steps” heading, if any) unless otherwise indicated. Specific gravity measurements can be made using a digital hydrometer or other suitable instrument. Formulation components, mixing time, mixing speed, temperature, component and mixture weight, and other variables can be monitored or controlled manually by the user or using an automated system (described in detail below) such as one including a computer and/or server. An automated system can also be used to automate recipe control, mixing process by recipe and weight, measures time of all functions, logs history of all functions, generate batch identification numbers and labels, and update an online or offline database of formulation batches and mixtures. An automated system can also restrict moving to the next step in the process unless a specific gravity measurement is taken and the result of such measurement meets pre-set limits.

### EXAMPLE 2

In one such preferred embodiment, the wood surface film concentrate is made in accordance with the following specifications.

TABLE 5

| Target Mix/Gallons 250 | | Variable | | | | |
|---|---|---|---|---|---|---|
| Description | % of mix | Gallons | Weight LBS | Weight Gr | Notes | Steps |
| ECB824BP Base Poly | 50% | 125 | 1066.25 | 483642.86 | | Add |
| Mergal K14 | 12% | 30 | 256.50 | 116346.44 | | add then Mix 5 mins |
| water | 37% | 92.5 | 771.91 | 350133.62 | | add then Mix 5 mins |
| Red Dye | 3.00% | 7.5 | 69.00 | 31297.87 | | Add |
| AntiFoam | 0.18% | 0.45 | 3.83 | 1734.99 | | add then Mix 5 mins |
| PolyPhase PW40 | 1% | 2.5 | 25.04 | 11355.68 | | add then Mix 10 mins |
| | lbs | Gr | | | | |
| Net Weight Liquids | 2192.52 | 983,155.79 | | | | |

Antifoam agents referenced herein and suitable for use with the present invention include Defoamer 15 commercially available from Dura-Chem, Inc. (18327 Pasadena Street, Lake Elsinore, Calif. 92530, Phone: 800-447-5008).
The wood surface film application mixture is then made from the wood surface film concentrate in Table 5 in accordance with the following specifications.

TABLE 6

| Target Mix/Gallons 2 | | Variable | | | | |
|---|---|---|---|---|---|---|
| Description | % of mix | Gallons | Weight LBS | Weight Gr | Notes | Steps |
| water | 50% | 1 | 8.35 | 3785.23 | | Add |
| DOT | 10% | | 1.80 | 816.91 | % of overall | Add then Mix 10 mins |
| | | | | | liquid weight | |
| AF21 | 40% | 0.8 | 7.84 | 3556.16 | | Add then Mix 5 mins |
| WoodSurfaceFilm Conc. | 10% | 0.2 | 1.75 | 795.60 | | Add then mix 5 mins |
| Dye | 0.20% | 0.004 | 0.04 | 16.69 | | Add (Optional) |
| AntiFoam | 0.20% | 0.004 | 0.03 | 15.42 | | Add (Optional) then mix 5 mins |
| | lbs | Gr | | | | |
| Net Weight Liquids | 18.01 | 8,169.11 | | | | |
| Gross Weight Mix | 19.81 | 8,986.02 | | | | |

As noted above, DOT as used in herein (including the tables) stands for Disodium Octaborate Tetrahydrate (Na₂B₈O₁₃.4H₂O). Suitable DOT can include BoraSol-WP® which is commercially available from Quality Borate Company, LLC (3690 Orange Place, Suite 495, Cleveland, Ohio 44122, Phone: 1-866-267-2837).

### EXAMPLE 3

In another preferred embodiment, the wood surface film concentrate is made in accordance with the following specifications.

TABLE 7

| Target Mix/Gallons 250 | | Variable | | | | |
|---|---|---|---|---|---|---|
| Description | % of mix | Gallons | Weight LBS | Weight Gr | Notes | Steps |
| ECB824BP Base Poly | 50% | 125 | 1066.25 | 483642.86 | | Add |
| Mergal K14 | 7% | 17.5 | 149.63 | 67868.76 | | add then Mix 5 mins |
| water | 42% | 105 | 876.23 | 397448.97 | | add then Mix 5 mins |
| Red Dye | 3.00% | 7.5 | 69.00 | 31297.87 | | Add |
| AntiFoam | 0.18% | 0.45 | 3.83 | 1734.99 | | add then Mix 5 mins |
| PolyPhase PW40 | 1% | 2.5 | 25.04 | 11355.68 | | add then Mix 10 mins |
| | lbs | Gr | | | | |
| Net Weight Liquids | 2189.96 | 981,993.46 | | | | |

The wood surface film application mixture is then made from the wood surface film concentrate in Table 7 in accordance with the following specifications.

TABLE 8

| Target Mix/Gallons 250 | | Variable | | | | |
|---|---|---|---|---|---|---|
| Description | % of mix | Gallons | Weight LBS | Weight Gr | Notes | Steps |
| water | 50% | 125 | 1043.13 | 473153.54 | | Add |
| DOT | 10% | | 225.12 | 102113.85 | % of overall | Add then Mix 10 mins |
| | | | | | liquid weight | |
| AF21 | 40% | 100 | 980.00 | 444520.52 | | Add then Mix 5 mins |
| WoodSurfaceFilm Conc. | 10% | 25 | 219.25 | 99450.13 | | Add then mix 5 mins |
| Dye | 0.20% | 0.5 | 4.60 | 2086.52 | | Add (Optional) |
| AntiFoam | 0.20% | 0.5 | 4.25 | 1927.77 | | Add (Optional) then mix 5 mins |
| | lbs | Gr | | | | |
| Net Weight Liquids | 2251.23 | 1,021,138.48 | | | | |
| Gross Weight Mix | 2476.35 | 1,123,252.33 | | | | |

### EXAMPLE 4

In another preferred embodiment, the wood surface film concentrate is made in accordance with the following specifications.

TABLE 9

| Target Mix/Gallons 250 | | Variable | | | | |
|---|---|---|---|---|---|---|
| Description | % of mix | Gallons | Weight LBS | Weight Gr | Notes | Steps |
| ECB824BP Base Poly | 34% | 85 | 725.05 | 328877.15 | | Add |
| Mergal K14 | 12% | 30 | 255.90 | 116074.29 | | add then Mix 5 mins |
| AntiFoam | 0.18% | 0.45 | 3.76 | 14214.48 | | Add |
| water | 51% | 127.5 | 1063.99 | 482616.61 | | add then Mix 5 mins |
| Red Dye | 3.00% | 7.5 | 69.00 | 31297.87 | | add then Mix 5 mins |
| PolyPhase PW40 | 3% | 7.5 | 75.11 | 34067.05 | | add then Mix 10 mins |
| | lbs | Gr | | | | |
| Net Weight Liquids | 2192.80 | 973,080.40 | | | | |

The specific gravity of the wood surface film concentrate in Table 9 is in the range of 1.023 to 1.030. The wood surface film application mixture is then made from the wood surface film concentrate in Table 9 in accordance with the following specifications.

TABLE 10

| Target Mix/Gallons 250 | | Variable | | | | |
|---|---|---|---|---|---|---|
| Description | % of mix | Gallons | Weight LBS | Weight Gr | Notes | Steps |
| water | 50% | 125 | 1043.13 | 473153.54 | | Add |
| DOT | 10% | | 224.66 | 101905.20 | % of overall | Add then Mix 10 mins |
| | | | | | liquid weight | |
| AF21 | 40% | 100 | 980.00 | 444520.52 | | Add then Mix 5 mins |
| WoodSurfaceFilm Conc. | 10% | 25 | 219.25 | 99450.13 | | Add then mix 5 mins |
| Dye | 0.00% | 0 | 0.00 | 0.00 | | Add (Optional) |
| AntiFoam | 0.20% | 0.5 | 4.25 | 1927.77 | | Add (Optional) then mix 5 mins |
| | lbs | Gr | | | | |
| Net Weight Liquids | 2246.63 | 1,019,051.96 | | | | |
| Gross Weight Mix | 2471.29 | 1,120,957.15 | | | | |

The specific gravity of the wood surface film application mixture in Table 10 is in the range of 1.127 to 1.132. In a preferred embodiment, the wood surface film application mixture of Table 10 is used on dimensional lumber, especially dimensional lumber that has a high moisture content, such as 19 to 33%. Dimensional lumber products are more prone to mold growth based on the higher moisture content and solid core cellulose make up. Additionally the dimensional lumber may require the film to have a higher permeability allowing it to breath as a result of the higher moisture contents.

### EXAMPLE 5

In another preferred embodiment, no fire retardant/inhibitor is included in the wood surface film application mixture.

TABLE 11

| Target Mix/Gallons 250 | | Variable | | | |
|---|---|---|---|---|---|
| Description | % of mix | Gallons | Weight LBS | Weight Gr | Notes |
| water | 90% | 225 | 1877.63 | 851676.37 | |
| DOT | 10% | | 209.97 | 94840.49 | % of overall liquid weight |
| WoodSurfaceFilm Conc. | 10% | 25 | 213.25 | 96728.57 | |
| Dye | 0.20% | 0.5 | 4.60 | | |
| AntiFoam | 0.20% | 0.5 | 4.25 | | |
| | lbs | Gr | | | |
| Net Weight Liquids | 2099.73 | 948,404.95 | | | |
| Gross Weight Mix | 2309.70 | 1,043,245.44 | | | |

The wood surface film concentrate set forth in Table 11 can be made in accordance with Table 7 or Table 9.

### EXAMPLE 6

In another preferred embodiment, a wood surface film application mixture is made to treat the cut ends of lumber. The end cut wood surface film application mixture is prepared in accordance with the following specifications.

TABLE 12

| Target Mix/Gallons 250 | | Variable | Weight | | |
|---|---|---|---|---|---|
| Description | % of mix | Gallons | LBS | Weight Gr | Notes |
| ECB824BP | 10% | 25 | 219.25 | 99450.13 | |
| water | 86% | 215 | 1794.18 | 813824.09 | |
| Red Dye | 2.00% | 5 | 46.00 | 20865.25 | |
| PolyPhase 678 | 2.00% | 5 | 48.40 | 21953.87 | |
| AntiFoam | 0.20% | 0.5 | 4.25 | 1927.77 | |
| | lbs | Gr | | | |
| Net Weight | 2112.08 | 858,570.98 | | | |
| Liquids | | | | | |

In the foregoing examples, certain components were used and physical aspects of those components such as weight were measured to assist in the calculations and formulations made using those components. Table 13 discloses the measurements related to those components and container used in the mixing and formulation of those examples.

TABLE 13

| | UOM | Weight LBS | Weight Gr | UOM | Weight LBS | Weight Gr |
|---|---|---|---|---|---|---|
| Description | | | | | | |
| Water | 1 gallon | 8.345 | 3785 | 1 OZ | 0.07 | 29.57 |
| ECB824BP Base Poly/“GLWP1023” | 1 gallon | 8.530 | 3869 | 1 OZ | 0.07 | 30.23 |
| WoodSurfaceFilm Concentrate | 1 gallon | 8.770 | 3978 | 1 OZ | 0.07 | 31.08 |
| AF-21 Fire Inhibitor | 1 gallon | 9.800 | 4445 | 1 OZ | 0.08 | 34.73 |
| DOT | 1 pound | 1.000 | 454 | 1 OZ | 0.01 | 3.54 |
| Water Repellency Additive | 1 gallon | 8.530 | 3869 | 1 OZ | 0.07 | 30.23 |
| PolyPhase 678 | 1 gallon | 9.680 | 4391 | 1 oz | 0.08 | 34.30 |
| PolyPhase PW40 | 1 gallon | 10.014 | 4542 | 1 OZ | 0.08 | 35.49 |
| Red Dye | 1 gallon | 9.200 | 4173 | | 0.07 | 32.60 |
| Blue Dye | 1 gallon | 8.350 | 3787 | | 0.07 | 29.59 |
| Anti Foaming Agent DuraChem DF-15 | 1 gallon | 8.500 | 3856 | | 0.07 | 30.12 |
| Mergal K14 | 1 gallon | 8.55 | 3878 | | 0.07 | 30.30 |
| Container Weights | | | | | | |
| 275 Gallon | gross/empty | 145 | 65771 | | | |
| 50 gallon Drum | gross/empty | 26 | 11793 | | | |
| 5 gallon pail/No Lid | gross/empty | 2.2 | 998 | | | |
| 245 Gallon-AF21 | gross/empty | 147-150 | | | | |

Termite testing: Testing of the inventive formulation and methods against Formosan subterranean termite and a southern yellow pine control was carried about by an independent testing laboratory (LSU AgCenter's Wood Durability Lab, Louisiana Forest Products Development Center, School of Renewable Natural Resources, LSU Agricultural Center, Baton Rouge, La. 70803, Phone: (225)578-4255). The objective of the study was to evaluate termite performance of the inventive formulation at five (5) retention levels on two substrates in comparison with untreated SYP lumber, Douglas-fir lumber, and OSB controls.

The formulation was prepared in accordance with the following mixing and application instructions. The formulation was prepared only once for all tests (termite, corrosion, and engineered wood products strength tests) performed to ensure consistency.

A stir bar was placed at the bottom of each container. A hot plate/stir table was used for the mixing application as follows:
1. Turn on hot plate temperature dial to #5 [approximately 90° C.]. Do not turn on stir motor at this time. Allow hot plate to warm up for several minutes.
2. Place container on top of hot plate. Allow to sit under temp for minimum 30 minutes.
3. Take temperature reading of mixture at the top 20% of solution in the container.
4. Temperature should approach 70 plus degrees Fahrenheit. At this time turn on the stir motor to #7 on the dial [approximately 500 RPMs]. Note depending on the solids formed from the DOT, further heating time may be needed for solids to break up.
5. Continue to blend allowing temperature to reach above 97 degrees Fahrenheit.
6. Once above 97 degrees, mixture is ready for application.
7. If samples to be treated fit into the top opening of the container, dip the sample using a tweezers into the chemical while under velocity and temperature. Maintain sample under chemistry for a minimum of 30 seconds.
8. If samples are larger than opening of container, then use a brush (typical paint brush or hard bristle brush) to apply to wood substrate. Dip brush into mixture while under velocity and apply to wood with a hard brushing movement.
9. Once treated allow to air dry. For air dry a minimum of 50 degrees ambient temperature is required for the film to form over a 24 hour period. If heat is applied, treated wood substrates can be put in an oven up to 150 degrees or higher, however must be less than boiling point of water. A heat gun can be used at 500 watts or more moving the heat back and forth across substrate. Avoid hot contact on same point for more than a few seconds or blistering may occur. If heat gun is utilized the film will form immediately and samples should be dry within minutes.

Samples were tested for resistance to Formosan subterranean termites (Coptotermes formosanus). The test included 50 treated samples plus 15 control samples for a total of 65 samples, 13 total treatment groups.

TABLE 13A

| | |
|---|---|
| Wood | ASTM Standards D 143², D 1037²; Test methods |
| testing | referenced in Section 4.0 of ICC-ES Acceptance |
| | Criteria AC257³ |
| Wood | ASTM Standards D 1413¹, D 1758¹, D2481³, D 3273, |
| preservatives | D 3345¹, and D 4445³; AWPA Standards E1¹, |
| | E5³, E7¹, E9³, E10¹, E11¹, E12¹, E16³, E18³, |
| | E22², E23² and E24¹; WDMA Standards TM-1¹ and TM-2¹ |

¹Approved Mar. 1, 2008.
²Approved Jul. 24, 2008.
³Approved Nov. 20, 2009.

TABLE 14

| ANOVA | | | |
|---|---|---|---|
| ID | Sample ID | Treatment | MC Sample ID |
| 1 | C1-C5 | SYP controls | 1mc-5mc |
| 2 | D1-D5 | DF controls | D6-D10 |
| 3 | O1-O5 | OSB controls | O6-O10 |
| 4 | 5-1 to 5-5 | 5 SYP | 5-6, 5-10 |
| 5 | 7-1 to 7-5 | 7 SYP | 7-6 to 7-10 |
| 6 | 10-1 to 10-5 | 10 SYP | 10-6 to 10-10 |
| 7 | 12-1 to 12-5 | 12 SYP | 12-6 to 12-10 |
| 8 | 15-1 to 15-5 | 15 SYP | 15-6 to 15-10 |
| 9 | 5-1 to 5-5 | 5 OSB | 5-6, 5-10 |
| 10 | 7-1 to 7-5 | 7 OSB | 7-6 to 7-10 |
| 11 | 10-1 to 10-5 | 10 OSB | 10-6 to 10-10 |
| 12 | 12-1 to 12-5 | 12 OSB | 12-6 to 12-10 |
| 13 | 15-1 to 15-5 | 15 OSB | 15-6 to 15-10 |

The test was performed in accordance with American Wood Protection Association (AWPA) E1-09 Standard Method for Laboratory Evaluation to Determine Resistance to Subterranean Termites (AWPA 2009). The single choice method was used. This test was started on Jun. 2, 2011 and concluded on Jun. 30, 2011. The test samples consisted of 50 treated samples, 5 Douglas Fir controls, 5 OSB controls, and 5 southern yellow pine sapwood controls. The untreated SYP control samples were milled on a band saw by the WDL personnel into 1 in.×1 in.×¼ in. test specimens. All untreated SYP samples were milled in the correct grain orientation and contained 4 to 6 rings per inch. All solid wood samples were 1 in.×1 in.×¼ in and the OSB samples were 1 in.×1 in.×panel thickness.

Sixty-five samples were tested using 5 replications per treatment. Each testing jar contained 150 g of autoclaved sand and 30 ml of distilled water. A sample was placed in each jar on top of the sand on an aluminum barrier to prevent chemical leaching into the sand. Four hundred termites were introduced to each jar on the side opposite to the sample. Termites were obtained from Brechtel State Park (Algiers, La) on Jun. 1, 2011 and added to the E1-06 test on Jun. 2, 2011. Samples of termites were taken, weighed and an average weight per termite determined. An average of 0.00406 g per termite was determined. Therefore, each jar contained 1.62 g of termites determined by weight.

After 28 days of exposure, the samples were removed and cleaned with distilled water to remove termites and sand, rated and oven dried. Each sample was rated based on the following AWPA rating system:
10 Sound, surface nibbles permitted
9 Light attack
7 Moderate attack, penetration
4 Heavy attack
0 Failure

The data obtained were analyzed for resistance with means and standard deviations determined (SPSS 2006). The Least Significant Difference (LSD) mean separation test procedure was used (Steel and Torrie 1980). Different capital letters within columns indicate that significant differences were found at the significance level α=0.05. Significant differences were not found among treatments when means shared the same letters within columns.

TABLE 15

| ANOVA | | | | | | |
|---|---|---|---|---|---|---|
| ID* | Mortality | LSD | Weight Loss | LSD | Ratings | LSD |
| 1 | 12.25% | A | 34.15% | A | 0.0 | A |
| 2 | 11.70% | A | 38.20% | A | 0.0 | A |
| 3 | 14.40% | B | 12.09% | B | 0.0 | A |
| 4 | 100.00% | C | 0.15% | C | 9.0 | B |
| 5 | 100.00% | C | 0.50% | C | 10.0 | BC |
| 6 | 100.00% | C | 0.98% | C | 10.0 | BC |
| 7 | 100.00% | C | 0.73% | C | 10.0 | BC |
| 8 | 100.00% | C | 0.51% | C | 10.0 | BC |
| 9 | 100.00% | C | 0.27% | C | 9.0 | B |
| 10 | 100.00% | C | 2.14% | C | 10.0 | BC |
| 11 | 100.00% | C | 1.76% | C | 10.0 | BC |
| 12 | 100.00% | C | 2.12% | C | 10.0 | BC |
| 13 | 100.00% | C | 0.69% | C | 10.0 | BC |

As shown in Table 16, each sample treated with the inventive formulation demonstrated 100% mortality for the Formosan subterranean termites. Without any intention to hypothesize or being held to any theory, it is believed that the fire retardant/inhibitor AF21 contributes to the death of Formosan subterranean termites and thus to the 100% mortality rate even when low levels (for example about 5%) of borate pesticide are used. Furthermore, each sample treated with the inventive formulation demonstrated no more than light attack to the wood product treated with the substrate.

TABLE 16

| Treatment | Sample ID | ANOVA ID* | Rating | LSD Group |
|---|---|---|---|---|
| SYP controls | C1-C5 | 1 | 0.0 | A |
| DF controls | D1-D5 | 2 | 0.0 | A |
| OSB controls | O1-O5 | 3 | 0.0 | A |
| 5 DF | 5-1 to 5-5 | 4 | 9.0 | B |
| 5 OSB | 5-1 to 5-5 | 9 | 9.0 | B |
| 7 DF | 7-1 to 7-5 | 5 | 10.0 | BC |
| 10 DF | 10-1 to 10-5 | 6 | 10.0 | BC |
| 12 DF | 12-1 to 12-5 | 7 | 10.0 | BC |
| 15 DF | 15-1 to 15-5 | 8 | 10.0 | BC |
| 7 OSB | 7-1 to 7-5 | 10 | 10.0 | BC |
| 10 OSB | 10-1 to 10-5 | 11 | 10.0 | BC |
| 12 OSB | 12-1 to 12-5 | 12 | 10.0 | BC |
| 15 OSB | 15-1 to 15-5 | 13 | 10.0 | BC |

The test results in Table 16 indicate that the inventive formulation can be used at concentrations lower than expected and still produce effective protection of wood products from termite damage. The concentrations of the inventive formulation are also lower than other wood product coatings and treatments used in the art, reducing cost and chemicals in the environment.

Weight Loss and Corrosion of Metal Coupons: Testing of the inventive formulation and methods against weight loss and corrosion of metal coupons was carried about by an independent testing laboratory (LSU AgCenter's Wood Durability Lab, Louisiana Forest Products Development Center, School of Renewable Natural Resources, LSU Agricultural Center, Baton Rouge, La. 70803, Phone: (225) 578-4255). The objective of the study was to perform the AWPA E12-08 (AWPA 2008) corrosion test with five metals against Douglas fir treated with the inventive formulation at five retention levels. Also included in this test were an untreated southern yellow pine (SYP) control, a Douglas fir (DF) control, and an alkaline copper quaternary (ACQ) positive control. The test included 10 samples of each metal for each treatment. Metal coupons, measuring 1 in.×2 in.× 1/16 in., were used in this test. The metals were SAE 1010 steel (steel), 85-15 red brass (brass), bare 2024-T3 aluminum alloy (alum), ASTM A123 hot dip zinc galvanized steel (HDGalv), ASTM A654 G90 galvanized steel (galv).

The tests were performed in accordance with American Wood Protection Association (AWPA) E12-08 Standard Method of Determining Corrosion of Metal In Contact With Treated Wood (AWPA 2008). Five different concentration levels of the inventive substrate were used for the test. All five treatment retentions were applied to Douglas fir lumber. As noted above, mixing and application instructions for the formulation application mixture was performed once for all treatments as set forth above.

E12-08 Testing Procedures: Wood Samples: Studs measuring 2 in.×6 in.×8 ft. that were free of defects were selected and purchased from a local retailer for producing the E12 wood blocks. Wood selected for this test was southern yellow pine sapwood, Douglas fir sapwood, and treated ACQ boards. All wood samples were milled into 19×38×75 mm (¾×1½×3 in) pieces using a table saw.

Metal Coupons: Ten replicates of each metal were used for each metal/treatment group. The metals used for this test were steel, brass, alum., HDgalv., and Galv. A total of 400 metal coupons were tested, 10 of each metal. The metal coupons were weighed, then cleaned and washed with an alcohol-acetone mixture and weighed again prior to use in the E12-08 test. The coupons were then dried for one hour, placed in desiccators for one hour, and then reweighed to the nearest milligram. These samples were then used for the E12-08 corrosion test.

After 366 hours of exposure at 49° C. (120° F.) and a relative humidity of 90%, the assemblies were removed; and the metal coupons were reweighed to the nearest milligram. The metal coupons were immersed in Evapo-Rust and sonicated for 1 hour. This process is repeated as needed in 1-hour intervals. The samples were finally rinsed in water, dried in a forced-draft oven at 40° C. for a minimum of 1 hour, cooled in a desiccator for 1 hour, and reweighed to the nearest milligram. Calculations were done to determine weight loss and mills per year.

The results are displayed in Table 17:

Steel: treatments 5, 7, 10, 12, and 15 had the top five MPY, values. These were followed by ACQ treated wood at 1.086. SYP and DF controls had two smallest MPY values.

Brass and Aluminum: all treatments did not cause any corrosion with zero MPY values.

Galvanized: ACQ treated wood had the highest MPY value. Treatments 5, 7, 10, 12, and 15 had MPY values below 0.15 with treatment 12 of the smallest MPY value at 0.098.

HDGaly: Similar to galvanized, ACQ had the highest MPY value of 0.37. The treatments 5, 7, 10, 12, and 15 had similar MPY values with SYP and DF controls.

Thus, the results (Table 17) showed that the treatment groups (5, 7, 10, 12, and 15) led to more corrosion on steel than the ACQ, SYP and DF controls. ACQ treatment led to more corrosion to Galvanized and HDGaly metals. For Brass, aluminum, galvanized, and HDGaly, the treatment groups performed similarly as SYP and DF untreated controls.

TABLE 17

| Treatment | Steel | Brass | Aluminum | Galvanized | HDGalv |
|---|---|---|---|---|---|
| SYP | 0.317 | 0.000 | 0.000 | 0.000 | 0.137 |
| ACQ | 1.086 | 0.000 | 0.000 | 0.453 | 0.370 |
| DF | 0.154 | 0.000 | 0.000 | 0.225 | 0.202 |
| 5 | 6.962 | 0.000 | 0.000 | 0.149 | 0.072 |
| 7 | 5.027 | 0.000 | 0.000 | 0.131 | 0.156 |
| 10 | 3.283 | 0.000 | 0.000 | 0.100 | 0.120 |
| 12 | 2.158 | 0.000 | 0.000 | 0.098 | 0.140 |
| 15 | 2.004 | 0.000 | 0.000 | 0.139 | 0.210 |

Flame Spread ASTM E84-08 Test—“Standard Method of Test for Surface Burning Characteristics of Building Materials”

In a preferred embodiment of the present invention, a flame retardant is used in the formulation to slow ignition and reduce smoke produced. Studies show that framing wood products dry in the wall cavities and especially in attics. This dry lumber can ignite so fast that it can be difficult to exit the building or provide enough time for fire fighters to fight the fires. Studies also show that many of the engineered lumber commonly used to build houses not only burn fast but cave in faster increasing the danger to fire fighters. The present invention significantly slows ignition and reduces smoke products without substantially increasing the cost of the wood products or having an effect on wood fiber strength as occurs with most currently available fire retardant treated (FRT) wood.

Testing by an independent laboratory (QAI Laboratories, 8385 White Oak Avenue, Rancho Cucamonga, Calif. 91730, Phone: 909.483.0250, www.qai.org) was performed on the inventive formulation and methods using the ASTM E84-08—Standard Method of Test for Surface Burning Characteristics of Building Materials—which is incorporated herein by reference. Testing was also completed by an independent laboratory (Bodycote Testing Group, 2395 Speakman Drive, Mississauga, Ontario, Canada, L5K 1B3, Tel: +1 (905) 822-4111, www.bodycote.com) using the extended ASTM D 3806 method which is also incorporated herein by reference. The results of those tests are reproduced in Table 18 herein.

TABLE 18

| | | Flame | | |
|---|---|---|---|---|
| | | Spread | Smoke | |
| Species | Size | Index | Index | Classification |
| Douglas Fir #2Btr | 2 × 4 | 20 | 95 | A |
| Spruce-Pine-Fir (SPF) Facia | 2 × 6 | 25 | 50 | A |

The present invention significantly reduced flame spread on wood products compared to a control in each of the tests performed in accordance with ASTM E84-08. The present invention also reduced smoke developed on wood products compared to a control.

Another advantage of the present invention is that uses and emits fewer VOCs and other chemical compounds than other wood product coatings and treatments. Those VOCs and other chemical compounds are associated with air quality problems and pollution.

An independent laboratory (Air Quality Sciences, Inc., 2211 Newmarket Parkway, Atlanta, Ga. 30067, Phone: 770-933-0638) tested the inventive formulation coating a 2×4 DF #2 BTR (four-sided area=0.0775 m²) for Total VOCs, Formaldehyde, and Total Aldehydes. The environmental chamber test was conducted following ASTM D 5116 in a 0.09±0.007 m³ chamber or ASTM D 6670 in a 5.7±0.3 m³ chamber. Analyses based on EPA Method IP-1B and ASTM D 6196 for VOCs by thermal desorption followed by gas chromatography/mass spectrometry (TD/GC/MS), and EPA IP-6A and ASTM D 5197 for selected aldehydes by high performance liquid chromatography (HPLC). BQL denotes below quantifiable level of 0.04 μg for TVOC based on a standard 18 L air collection volume or 0.1 μg for formaldehyde and other aldehydes based on a standard 45 L air collection volume.

TABLE 19
ENVIRONMENTAL CHAMBER TEST REPORT WITH MODELING

| | 24 HR | CERTIFICATION | | 168 HR PREDICTED | |
|---|---|---|---|---|---|
| | EMISSION | CRITERIA | | CONCENTRATION | |
| | FACTOR | | CHILDREN & | | CHILDREN |
| ANALYTE | (μg/m² · hr) | GREENGUARD | SCHOOLS | GREENGUARD | & SCHOOLS |
| TVOC | 63.5 | ≦0.5 mg/m³ | ≦0.22 mg/m³ | 0.029 mg/m³ | 0.029 mg/m³ |
| Formaldehyde | BQL | ≦0.05 ppm | ≦0.0135 ppm | <0.001 ppm | <0.001 ppm |
| Total Aldehydes | 45.7 | ≦0.1 ppm | ≦0.043 ppm | 0.011 ppm | 0.011 ppm |

An independent laboratory also tested emission factors of identified individual volatile organic compounds at 24 elapsed exposure hours, the results of which are reproduced herein.

TABLE 20

| | | EMISSION |
|---|---|---|
| CAS | | FACTOR |
| NUMBER | COMPOUND IDENTIFIED | μg/m² · hr |
| 80-56-8 | Pinene, α (2,6,6-Trimethyl- | 42.6 |
| | bicyclo[3.1.1]hept-2-ene) | |
| 138-86-3 | Limonene (Dipentene; 1-Methyl-4-(1- | 6.3 |
| | methylethyl)cyclohexene) | |
| 149-57-5 | Hexanoic acid, 2-ethyl^{†} | 5.1 |
| 127-91-3 | Pinene, β (6,6-Dimethyl-2-methylene- | 4.9 |
| | bicyclo[3.1.1]heptane) | |
| 586-62-9 | Cyclohexene, 1-methyl-4- | 3.2 |
| | (1-methylethylidene)* | |
| 128-37-0 | 2,6-Di-tert-butyl-4-methylphenol (BHT)^{†} | 2.4 |

*Indicates NIST/EPA/NIH best library match only based on retention time and mass spectral characteristics.
^{†}Denotes quantified using multipoint authentic standard curve. Other VOCs quantified relative to toluene.
Quantifiable level is 0.04 μg based on a standard 18 L air collection volume.

An independent laboratory also tested emission factors of selected aldehydes at 24 elapsed exposure hours, the results of which are reproduced in Table 21.

TABLE 21

| | | EMISSION |
|---|---|---|
| CAS | | FACTOR |
| NUMBER | COMPOUND IDENTIFIED | μg/m² · hr |
| 4170-30-3 | 2-Butenal | BQL |
| 75-07-0 | Acetaldehyde | 42.2 |
| 100-52-7 | Benzaldehyde | BQL |
| 5779-94-2 | Benzaldehyde, 2,5-dimethyl | BQL |
| 529-20-4 | Benzaldehyde, 2-methyl | BQL |
| 620-23-5/104-87-0 | Benzaldehyde, 3- and/or 4-methyl | BQL |
| 123-72-8 | Butanal | BQL |
| 590-86-3 | Butanal, 3-methyl | BQL |
| 50-00-0 | Formaldehyde | BQL |
| 66-25-1 | Hexanal | 3.5 |
| 110-62-3 | Pentanal | BQL |
| 123-38-6 | Propanal | BQL |

BQL = Chemical below quantifiable level of 0.1 μg based on a standard 45 L air collection volume.

The independent testing (Table 21) indicates that the inventive formulation as applied to wood products resulted in the emission of low levels of VOCs and selected aldehydes. Reducing levels of VOCs and aldehydes is advantageous compared to other wood product preservatives, coatings and treatments because those chemical compounds may contribute to air pollution, and in some instances be suspected carcinogens. It should be noted that alpha-pinene levels result primarily from the wood on which the substrate was coated rather than the instant formulation.

Engineered wood products: Another preferred embodiment of the instant invention is for the coating of engineered wood products (EWPs). Engineered wood products consist of a combination of smaller components to make a structural product, designed using engineering methods. They are an alternative to traditional sawn lumber. Some examples of engineered wood products include plywood, oriented strand board (OSB), glued laminated timber (glulam), I-joists, trusses, and structural composite lumber (SCL) that includes laminated veneer lumber (LVL), parallel strand lumber (PSL), and laminated strand lumber (LSL).

Among the concerns with using engineered wood products are the effects of coatings or impregnation methods have on maintaining strength of the EWPs, maintaining the paintability of the EWPs, and reducing the flammability of EWPs (addressed above). The instant invention addresses these concerns.

An independent testing laboratory (LSU AgCenter's Wood Durability Lab, Louisiana Forest Products Development Center, School of Renewable Natural Resources, LSU Agricultural Center, Baton Rouge, La. 70803, Phone: (225)578-4255) tested the strength of EWPs coated the inventive formulation. The objective of the study was to perform the ASTM D198 standard test method of static test of lumber in structural size (flexure). The product we tested was cut from ILevel Microlam 1.9 E Douglas-fir LVL 1¾″×11⅞″ which was procured by the test sponsor from Pine Tree Lumber and sent to the LSU WDL. The LVL was treated by the LSU WDL with inventive formulation at the 15% retention level. Also included in this test was an untreated ILevel Microlam (LVL) control. The test included 20 samples of each treated and untreated LVL.

The tests were performed in accordance with American Society for Testing and Materials (ASTM) D198 Standard Test Methods of Static Tests of Lumber in Structural Sizes. The Flexure procedure was followed for the test method.

One concentration level inventive formulation was used at a 15% mix. The LVL samples were dipped in the mixture for 30 seconds each. After dipping the samples were set to dry using a box fan. The specimens were conditioned to a constant weight to moisture equilibrium in the desired environment.

The test is used to determine the flexural properties of laminated wood, such as beams of rectangular cross section. The beams were deflected at a rate of outer strain of 0.0010 in./in. per min. and a maximum load until rupture occurred. The device used to deflect the samples was an Instron model 5582.

Wood selected for this test was cut from ILevels Microlam 1.9E Douglas-fir. LVL 1¾″×11⅞″. The testing samples were milled to 1¾″×3″×30″ and received by the lab at these dimensions. Two shipments of LVL samples were received by the lab. The two shipments had different densities therefore they were kept separate as two individual groups for treating purposes. Each group contained 20 specimens that were separated into 10 specimens each. Of those 20 specimens, 10 were dip treated with the inventive formulation and 10 were untreated. The total testing consisted of 20 specimens that were treated and 20 that were untreated.

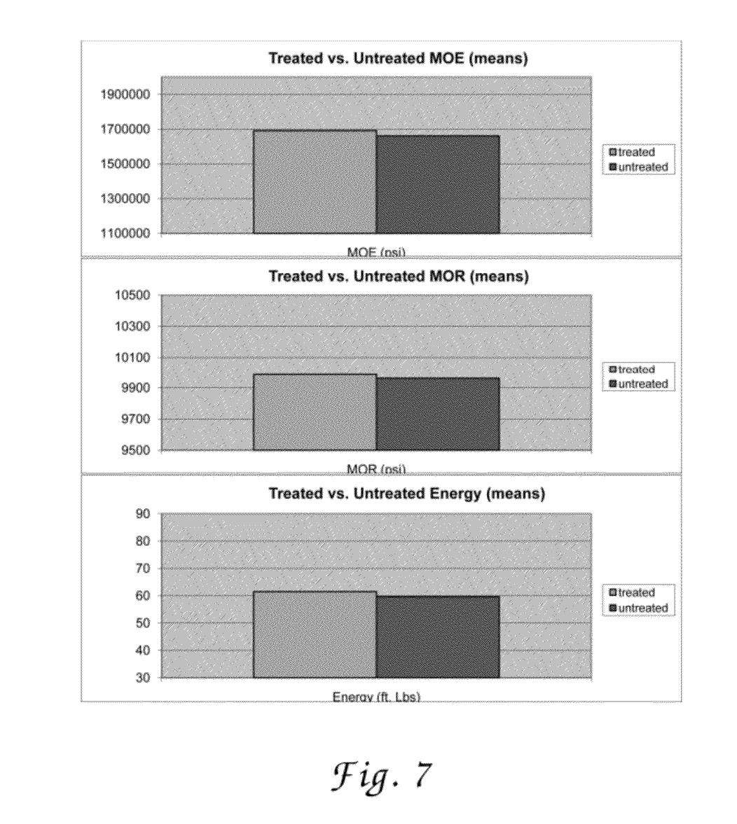

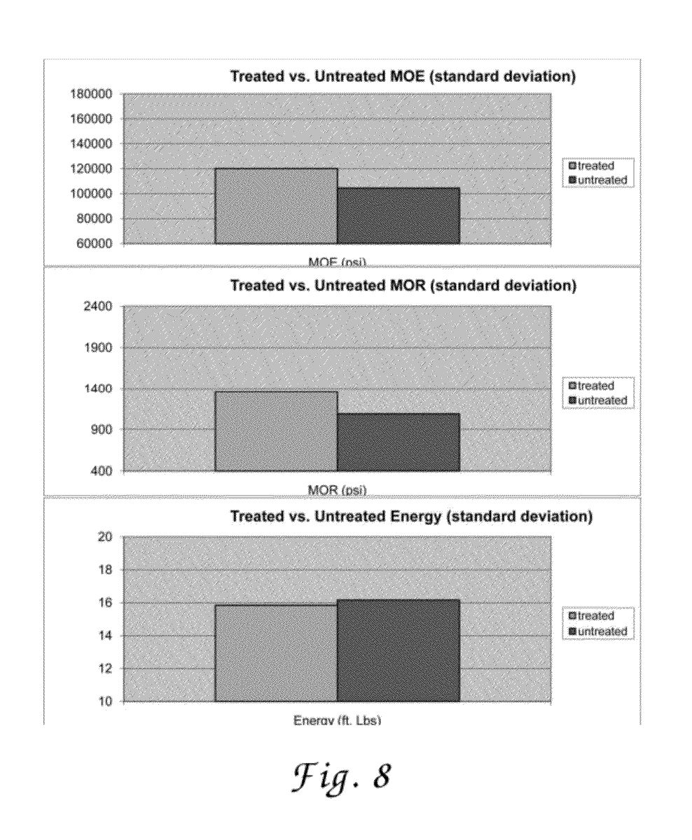

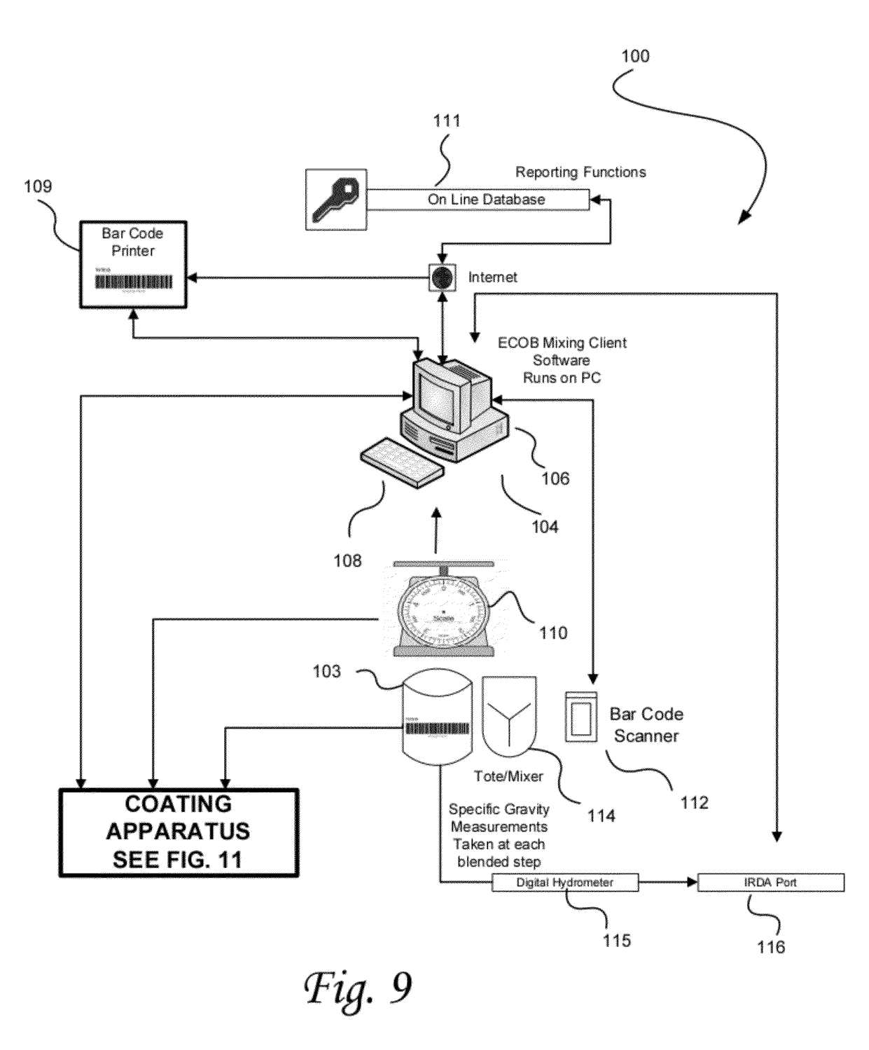

The results provided individual flexural data for the primary data of interest (i.e., MOE, MOR, and energy) (FIGS. 7 & 8). The results also provide information on means and standard deviations of the treated and untreated groups. The results provided significant differences determined between treatments for the experimental variables using the LSD test procedure but showed no significant differences when the data was grouped based on sample density.

Modulus of Elasticity (MOE—Bending Stiffness): The mean MOE data for both untreated and treated samples was very closely related. The mean MOE value for untreated samples was 1,661,206.10 psi vs. 1,690,850.48 psi resulting in no significant difference among these two groups. The standard deviation for the treated samples 117,120.68 psi had a large spread among all samples compared to the untreated samples 101,844.85 psi which had a smaller spread.

Modulus of Rupture (MOR—Bending Strength): The mean MOR data for both untreated and treated samples was also closely related. The mean MOR value for the untreated samples was 9961.3 psi vs. 9986.5 psi for the treated samples resulting in no significant difference among these two groups. Again the same can be said here, for the treated samples had a large spread among all samples 1356.81 psi compared to the untreated samples 1087.70 psi, which had a smaller spread. After breaking sample T2 was found to contain a 1″ knot on the tension face of the specimen. The data could be culled but was not for this report.

Energy (foot pounds): The mean energy data for both untreated and treated samples was also closely related. The mean energy value for the untreated samples was 56.7 ft lbs vs. 56.4 ft lbs for the treated samples resulting in no significant difference among these two groups. With this measurement the range for the untreated group was slightly higher than the treated group, 16.16 ft lbs for the untreated vs. 15.84 ft lbs for the treated group.

The results showed that there was no significant difference between the treated and untreated groups for MOR, MOE, and energy (FIGS. 7 & 8). The treated samples did have a larger standard deviation among the samples. The treated mean values were slightly higher than corresponding untreated values for MOR and MOE but were slightly lower for energy. The determination can be made that the inventive formulation treatment had no significant effect on MOE, MOR, and energy based on the results of this testing.

In one preferred embodiment, the wood surface film application mixture of Table 8 is used to coat EWPs and panels and provide protection against water, mold, rot, fungal attack and insect damage. Engineered wood products and panels typically have very low moisture contents, such as 8 to 12% moisture content, and are very susceptible to moisture causing swell. In the case of engineered lumber, moisture is a problematic because swell is in turn problematic were tight tolerances are required. As a result, a wood surface film application mixture such as that provided in Table 8 may be preferable to treat EWPs compared, for example, to a wood surface film application mixture as in Table 10.

Automated Control of Formulation: In accordance with the invention, the process involved in creating and applying the formulation to wood products has been automated. The terms “automated,” “automatic” or “automatically” as those terms are used interchangeably herein, are meant to include process which are processor or computer assisted, enhanced, controlled, or driven, including but not limited to methods contributing to the formulation, creation or application of compositions for protecting wood and wood products from damage caused by any source, including, but not limited to water, mold/wood rot, fire and/or insects. Precise calculations, measurements, temperature requirements, mixing requirements, and order of components added can be critical to the proper formulation of the instant invention and its effective and successful application to wood products. Automation of the process can assist in achieving the required precision.

The present invention can include an automated system including automated equipment that is run by a computer that includes a processor and/or a computer program embodied on a computer-readable medium. For example, a computer can be used to operate the automated equipment, assist human interactive events within an automated process, take and record measurements within the process, store data and provide written labeling or other recorded information about a batch within the process and/or restrict or prohibit certain steps in a process unless a condition or set conditions has been met to prior to proceeding.

It should be noted that although the present invention is described with respect to automated systems, as will be appreciated by one of ordinary skill in the art, the present invention may also apply to any system and/or equipment that is operated by a software environment and/or an equipment model capable of being connected to or monitored by a processor or computer. Further, although the present invention is described with respect to processors and computer programs, as will be appreciated by one of ordinary skill in the art, the present invention may also apply to any system and/or program that is capable of converting a software environment. For example, as used herein, the term processor is not limited to just those integrated circuits referred to in the art as processors, but broadly refers to computers, processors, microcontrollers, microcomputers, programmable logic controllers, application specific integrated circuits, and other programmable circuits. The processor may be part of a computer that may include a device, such as, a floppy disk drive or compact disc-read-only memory (CD-ROM) drive, for reading data from a computer-readable medium, such as a floppy disk, a CD-ROM, a magnetooptical disk (MOD), or a digital versatile disc (DVD).

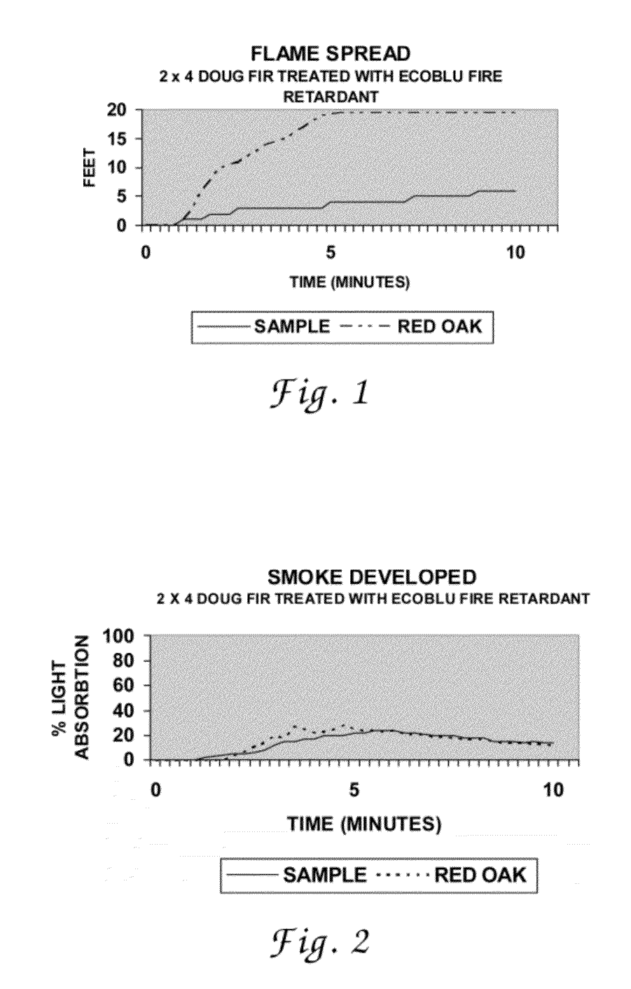

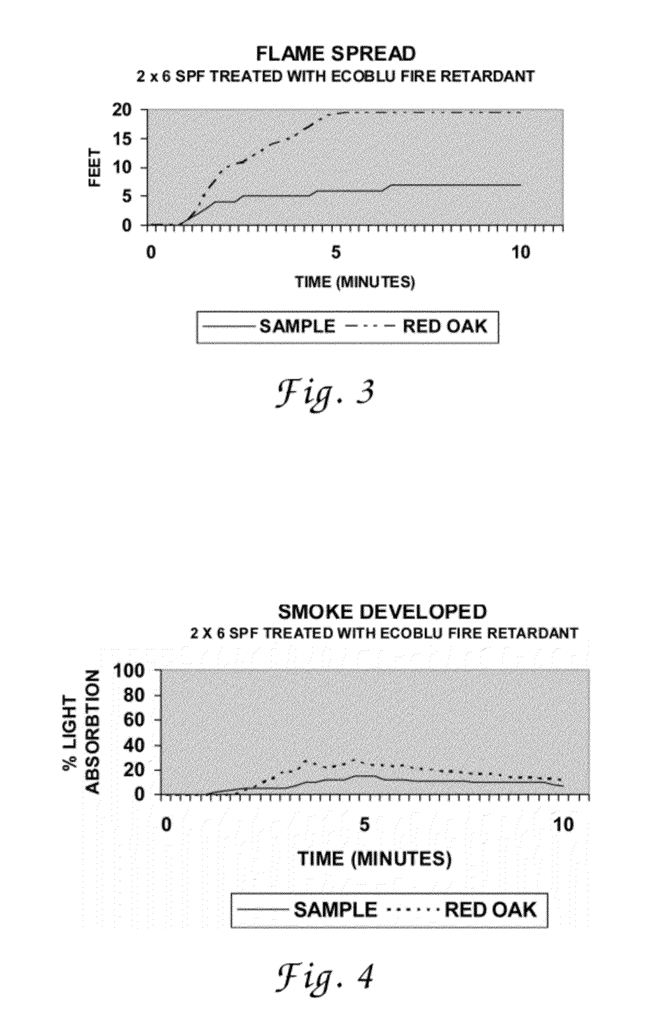

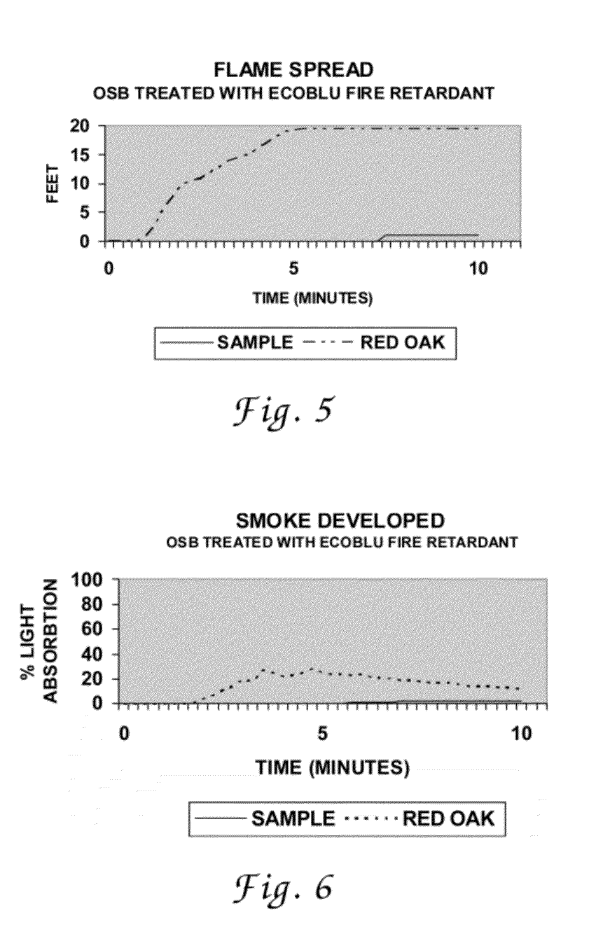

FIG. 1 is a schematic view of an exemplary automated system 100 for use with the instant invention. Automated system 100 includes automated equipment and at least one computer 104 that includes a processor 106 and is electronically coupled to a user interface 108. Although the exemplary embodiment illustrates several pieces of automated equipment, as will be appreciated by one of ordinary skill in the art, system 100 may include any suitable number of automated equipment pieces. Further, although computer 104 is illustrated as being electronically coupled to several pieces of automated equipment and user interface 108, as will be appreciated by one of ordinary skill in the art, computer 104 may be remote from, and wirelessly communicate with, automated equipment and/or user interface 108.

In the exemplary embodiment, processor 106 is configured to run automation software including a program configured to control automated equipment 102. In one embodiment, the automation software is embodied in a program embodied on a computer-readable medium. Further, in the exemplary embodiment, the automation software is configured to control any type of automated equipment that may be used during an automated application or process. For example, automated equipment 102 may include, but is not limited to limited to, machinery, electrical equipment, computers, databases, and/or servers. Moreover, in the exemplary embodiment, user interface 108 enables a user to control, change, and/or update the automation software. During operation, processor 106 runs automation software to operate automated equipment 102. More specifically, the automation software includes instructions that instruct each step performed by a user and/or each individual piece of automated equipment 102 to perform an automated application.

In a preferred embodiment, processor 106 is configured to run automation software including a program and database 111 in which recipes or other stored component information, including but not limited to weights on scale 110, amounts, volumes in a tote mixer, specific gravities from a digital hydrometer 115, mixing times, mixing temperatures in 114, and the like are stored. Processor 106 can be configured to require completion of each step (unless optionally overridden manually) before the next step can be performed. Processor 106 can further be configured to require a test measurement be taken before the next step can be performed. Processor 106 can further be configured to require that the result of the test measurement fall within a specified range before the next step can be performed. For example, in a mixture being prepared in accordance with the automated software and system, a specific gravity measurement of the mixture might be required 115 and the result of that specific gravity measurement might be required to fall within a specified range before the next step could be completed. As another example, a temperature measurement might be required at each step of the process to ensure that a specific temperature range is maintained throughout the process. If by way of non-limiting example, the specific gravity or temperature measurement is not taken, or if the result of said measurements is unsatisfactory, the process could be automatically halted by the processor 106, computer 104, and/or software until the correct results are achieved.

In a preferred embodiment, processor 106 is configured to run automation software including a program configured with a scale 110 and to record all weight measurements taken on said scale 110. For example, in a mixture being prepared in accordance with the invention and the automated software and system, a particular temperature may need to be maintained throughout the process, or in a non-limiting example, changes to the temperature corresponding with specific steps in the process may need to occur. If the specific temperature (or temperature change) is not maintained or achieved, the automated software and system may alert the user and/or halt the process until the required temperature (or temperature change) is met. In another example, a certain level stirring or other agitation may be required for a mixture being prepared in accordance with the invention and the automated software and system. In a preferred embodiment, processor 106 is configured to run automation software including a program configured with a heat bench, stirring apparatus 114 or a combination of the same. In a preferred embodiment, the formulation is stirred or otherwise agitated at a constant velocity through mechanical means understood in the art. In the event that a portion of the formulation falls out of solution, the formulation can be re-suspended through mechanical means understood in the art. In another preferred embodiment, the temperature of the solution should be controlled to a range of about 50-120° F. with a further preferred range of 70-98° F.

In a preferred embodiment, processor 106 is configured to run automation software including a program configured to print labels 109, including by way of non-limiting example, bar code labels, for each batch made. Other possible examples include the creation of RFID tags, wired or wireless inventory management software tracking and recordation and other known ways of recording what was made, when it was made, and the like.

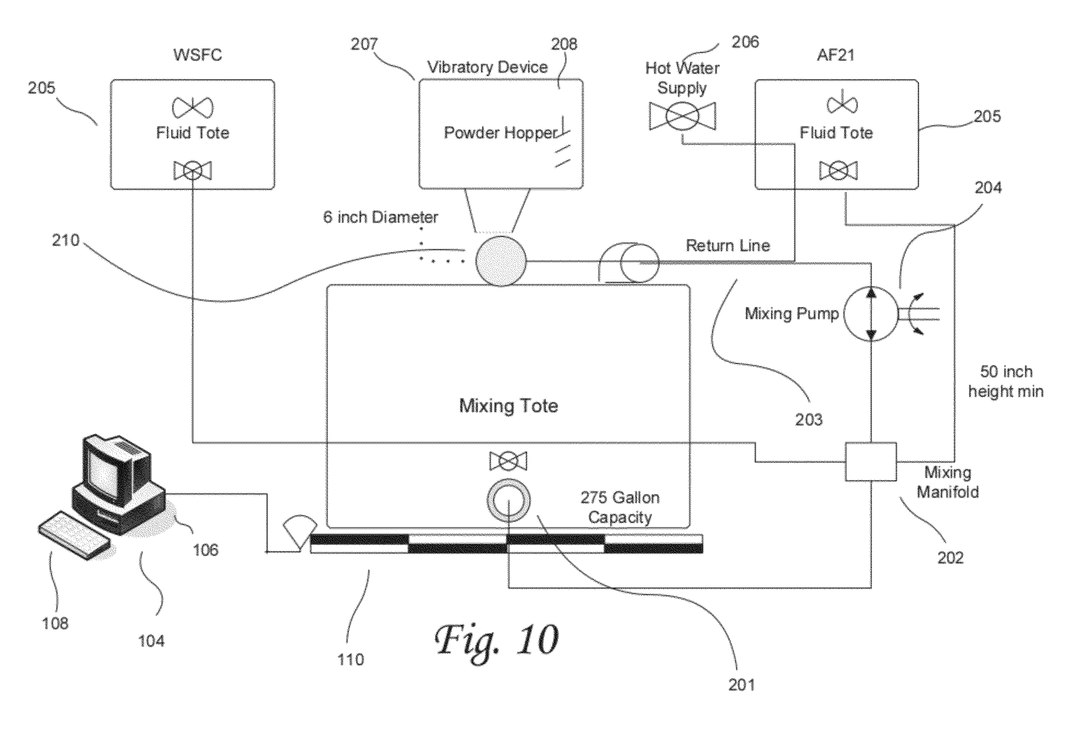

In a preferred embodiment, processor 106 is configured to run automation software including a program configured to an automated coating machine generally set forth in 113 and FIG. 10. For example, in a mixture being prepared in accordance with the invention and the automated software and system, the completed mixture 300 can be applied by flood coating in which the volume of mixture added to the flood bed 305 including gravity rollers 305 and an optional airknife 306 is controlled by the processor, computer and/or software according to the number of wood products to be coated, the rate or speed at which said wood products are moving throw the coating machine 305, 306, 307, and whether any drying element is being used. In a preferred embodiment, processor 106 may be configured to run automation software including a program configured to re-fill the coating chamber 302 via 303 and into 307 if its volume falls below a certain level, alert the user that additional mixture is needed 302, and/or start or restart an automated process for making more of the mixture 300.

In a preferred embodiment of the invention, the mixing process can also be automated using a processor 106 and computer system 104. A mixing tote 201 can be placed on a scale 110 and weight measurements can be recorded by the processor 106 as mixtures are created. Fluid totes 205 contain liquids needed for the formulation or mixture. A powder hopper 207 can hold non-aqueous materials needed for the formulation or mixture. The powder hopper 207 may optionally include a vibratory device 208 which assists in getting non-aqueous materials out of the hopper 207 and optionally into solution via a hot water supply 206. A mixing pump 204 and mixing manifold 202 may be used to move fluids back and forth between connected containers shown in FIG. 10 and may be automated using processor 106 in conjunction with the mixing tote 201 and measurements taken by scale 110. In one embodiment, lines capable of carrying fluid and connecting the mixing pump 204, mixing manifold 202, and fluid totes 205 may be controlled manually or in an automated way. The processor 106 can control the mixing in a particular order programmed into the software by a user, from a stored database 111 or from the Internet The processor 106 can also control mixing based on weight measurements recorded on the scale 110 or specific gravity measurements taken in accordance with 115. Such measurements may be logged directly into the processor 106 and/or computer 104 and viewed or manipulated via the user interface 108. Such measurements may also be logged through a wireless connection to the computer 104 or other wired Or non-wired port such as an IRDA port 116.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

What is claimed is:

1. A process for treating a substrate comprising the steps of:
(a) optionally drying the substrate to a moisture content below twenty percent (20%);
(b) diluting an acrylate copolymer with water;
(c) adding a borate pesticide to the solution of step (b);
(d) optionally adding a fire retardant/inhibitor;
(e) adding water to the solution of step (c) or step (d) to prepare a diluted coating solution suitable to adhere to the substrate surface when applied to the substrate; and
(f) applying the diluted coating solution from step (e) to the substrate.

2. The process according to claim 1 wherein said process protects the substrate against water damage.

3. The process according to claim 1 wherein said process protects the substrate against fungal damage.

4. The process according to claim 3 wherein said fungi are wood decay fungi.

5. The process according to claim 1 wherein said process protects the substrate against mold damage.

6. The process according to claim 1 wherein said process protects the substrate against wood ingesting insect damage.

7. The process according to claim 6 wherein the insects are Formosan termites.

8. The process according to claim 6 wherein the insects are killed after coming into contact with the substrate coated with coating solution.

9. The process according to claim 1 wherein said process protects the substrate against fire damage.

10. The process according to claim 7 wherein said process slows ignition of the substrate by fire.

11. The process according to claim 7 wherein said process reduces the amount of smoke produced when the substrate is ignited by fire.

12. The process according to claim 1 wherein said substrate is an engineered wood product.

13. The process according to claim 12 wherein said engineered wood product is selected from the group consisting of plywood, oriented strand board, glued laminated timber, I-joists, trusses, structural composite lumber, laminated veneer lumber, parallel strand lumber, and laminated strand lumber.

14. The process of claim 1, wherein said dilution in step (b) brings the solids content of the acrylate copolymer down to below about 50%.

15. The process of claim 7, wherein said dilution brings the solids content of the acrylate copolymer down to below about 33%.

16. The process of claim 1, wherein said diluted coating solution in step (e) has a solids content from between about 5 to 30%.

17. The process of claim 1, wherein said diluted coating solution in step (e) has a solids content from between about 17 to 21%.

18. The process of claim 1, wherein said borate pesticide content is about 5% and wherein said fire retardant/inhibitor is AF21.

19. The process of claim 1, wherein said substrate is wood.

20. An aqueous composition for treating a wood substrate suitable to adhere to the substrate surface when applied to said substrate, said composition comprising:
(a) an acrylate copolymer
(b) a combination of chloromethylisothiazolinone and methylisothiazolinone (CMIT/MIT)
(c) optionally an anti foam agent
(c) water
(d) optionally a colorant
(e) optionally a fire inhibitor and
(e) 3-Iodo-2-propynyl butylcarbamate (IPBC)
